(19) United States
(12) Patent Application Publication
(10) Pub. No.: US 2005/0096570 A1
(43) Pub. Date: May 5, 2005

(54) Method of treating cardiac arrest

(75) Inventors: James Adam Palazzolo, Sunnyvale, CA (US); Darren R. Sherman, Sunnyvale, CA (US)

Correspondence Address: Crockett & Crockett, Suite 400, 24012 Calle De La Plata, Laguna Hills, CA, 92653, US

(73) Assignee: Revivant Corporation

(21) Appl. No.: 10/702,870

(22) Filed: Nov. 5, 2003

(51) Int. Cl. A61H 31/00

(52) U.S. Cl. 601/44

(57) ABSTRACT

A method of treating cardiac arrest patients using epinephrine and a device that uses a belt to perform anterior-posterior closed chest compressions. In animal experiments the combination of epinephrine and a belt-driven anterior-posterior chest compression device produced high levels of coronary perfusion pressure, myocardial blood flow and cerebral blood flow relative to both pre-arrest levels and relative to conventional CPR techniques.

### FIELD OF THE INVENTION

The inventions described below relate the field of cardiopulmonary resuscitation.

### BACKGROUND OF THE INVENTION

Cardiopulmonary resuscitation (CPR) is a well-known and valuable method of first aid used to resuscitate people who have suffered from cardiac arrest. CPR requires repetitive chest compressions to squeeze the heart and the thoracic cavity to pump blood through the body. Artificial respiration, such as mouth-to-mouth breathing or a bag mask apparatus, is used to supply air to the lungs. When a first aid provider performs manual chest compression effectively, blood flow in the body is about 25% to 30% of normal blood flow. However, even experienced paramedics cannot maintain adequate chest compressions for more than a few minutes. Hightower, et al., Decay In Quality Of Chest Compressions Over Time, 26 Ann. Emerg. Med. 300 (September 1995). Thus, CPR is not often successful at sustaining or reviving the patient.

If blood flow can be adequately maintained, then cardiac arrest victims could be sustained for extended periods of time. Occasional reports of extended CPR efforts (45 to 90 minutes) have been reported, with the victims eventually saved by coronary bypass surgery. See Tovar, et al., Successful Myocardial Revascularization and Neurologic Recovery, 22 Texas Heart J. 271 (1995).

In efforts to provide better blood flow and increase the effectiveness of bystander resuscitation efforts, various mechanical devices have been proposed for performing CPR. In one variation of such devices, a belt is placed around the patient's chest and the belt is used to effect chest compressions. Our own patents, Mollenauer et al., Resuscitation device having a motor driven belt to constrict/compress the chest, U.S. Pat. No. 6,142,962 (Nov. 7, 2000); Sherman, et al., CPR Assist Device with Pressure Bladder Feedback, U.S. Pat. No. 6,616,620 (Sep. 9, 2003); Sherman et al., Modular CPR assist device, U.S. Pat. No. 6,066,106 (May 23, 2000); and Sherman et al., Modular CPR assist device, U.S. Pat. No. 6,398,745 (Jun. 4, 2002) show chest compression devices that compress a patient's chest with a belt. Our patent application Ser. Nos. 10/686,184, 10/686,185, 10/686,186, 10/686,188 and 10/686,549, all filed on Oct. 14, 2003, the entireties of which are hereby incorporated by reference, also show examples of our chest compression devices. (Our chest compression devices drive a belt to perform compressions and are easily carried by a rescuer to the scene of an emergency. Some models of our devices are currently marketed under the trademark AutoPulse™.) Another variation of devices uses a piston to mechanically compress the chest. Examples of these devices include Barkalow, Pneumatically Operated Closed Chest Cardiac Compressor, U.S. Pat. No. 3,364,924 (Jan. 23, 1968) and Mosley, et al., Sliding Arm Lock Assembly, U.S. Pat. No. 3,995,963 (Dec. 7, 1976).

Our own advances in chest compression devices have made it easier to apply closed chest compressions and have increased a patient's chances of surviving cardiac arrest. The method described below further improves upon the greatly enhanced survival rate for cardiac arrest victims treated with our chest compression devices.

### SUMMARY

During animal testing we unexpectedly found that combining epinephrine with our chest compression device disproportionately increased coronary perfusion pressure, myocardial blood flow and cerebral blood flow compared to combining epinephrine with other means for applying chest compressions. Coronary perfusion pressure, myocardial blood flow and cerebral blood flow met or exceeded pre-arrest levels in pigs when epinephrine and our device were used together. Prior to our experiments, it was not possible to attain pre-arrest levels of coronary perfusion pressure, myocardial blood flow and cerebral blood flow with any combination of drugs and manual chest compressions (as performed according to American Heart Association basic life support guidelines). The combination of drugs and manual chest compressions can attain about 30% to 35% pre-arrest levels under ideal conditions.

We also tested the effect of piston-driven CPR both with and without using epinephrine and we tested the effect of manual CPR. Epinephrine combined with a piston-driven chest compression device increased blood flow relative to manual CPR or to a piston-driven device alone, but only to the degree that was expected.

High coronary perfusion pressure, myocardial blood flow and cerebral blood flow levels are correlated with an increased rate of survival in cardiac arrest patients. Since combining epinephrine and our chest compression device greatly increases coronary perfusion pressure, myocardial blood flow and cerebral blood flow in pigs, and since a human study has indicated that our device increases coronary perfusion pressure in humans relative to manual CPR, human patients will more likely survive cardiac arrest if quickly treated with both epinephrine and our chest compression device.

### BRIEF DESCRIPTION OF THE DRAWINGS

FIG. 1 shows the chest compression device fitted on a patient.

FIG. 2 is a cross section of the chest compression device with the guide spindles laterally spaced from each other.

FIG. 3 is a table showing average blood pressure in pigs during chest compressions, wherein chest compressions were performed using three different techniques and wherein the chest compression techniques were performed without the provision of epinephrine.

FIG. 4 is a table showing average blood pressure in pigs during chest compressions, wherein chest compressions were performed using two different techniques and wherein the chest compression techniques were performed with the provision of epinephrine.

FIG. 5 is a chart showing average myocardial blood flow in pigs during chest compressions, wherein chest compressions were performed using two different techniques and wherein each chest compression technique was performed both with and without the provision of epinephrine.

FIG. 6 is a chart showing average cerebral blood flow in pigs during chest compressions, wherein chest compressions were performed using two different techniques and wherein each chest compression technique was performed both with and without the provision of epinephrine.

FIG. 7 is a chart showing average coronary perfusion pressure in pigs during chest compressions, wherein chest compressions were performed using two different techniques and wherein each chest compression technique was performed with and without the provision of epinephrine.

FIG. 8 is a chart showing the percentage of pre-arrest blood flow in pigs during chest compressions, wherein chest compressions were performed using two different techniques and wherein each chest compression technique was performed with and without the provision of epinephrine.

FIG. 9 is a table showing average blood pressure in pigs during chest compressions, wherein chest compressions were performed using two different techniques and wherein the chest compression techniques were performed both with and without the provision of epinephrine.

### DETAILED DESCRIPTION OF THE INVENTIONS

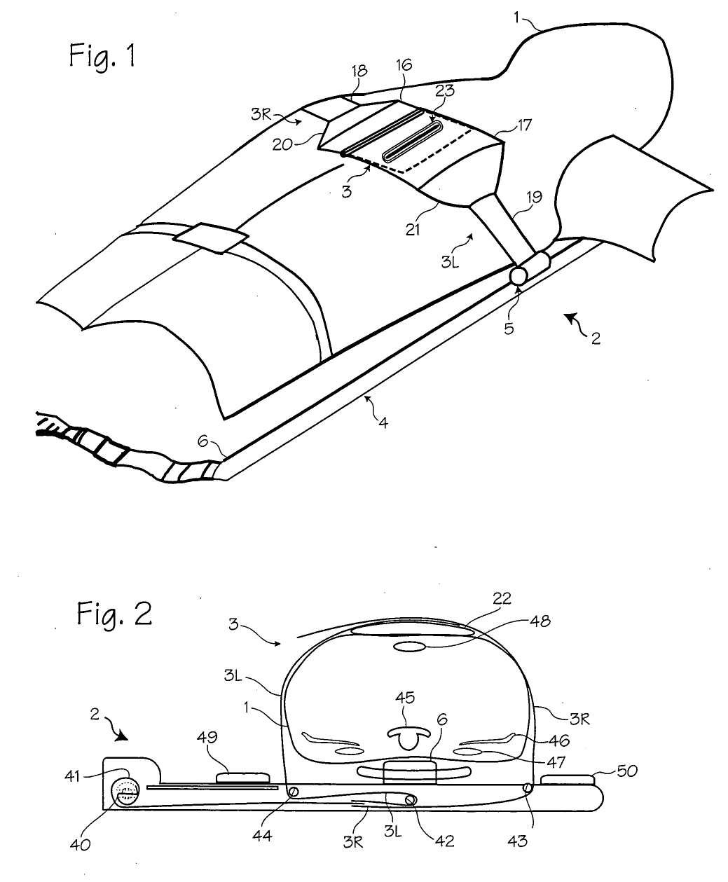

FIG. 1 shows our portable chest compression device fitted on a patient 1. Our chest compression device 2 applies compressions with the belt 3, which has a right belt portion 3R and a left belt portion 3L. The device 2 includes a belt drive platform 4 and a compression belt cartridge 5 (which includes the belt). The belt drive platform includes a housing 6 upon which the patient rests, a means for tightening the belt, a processor and a user interface disposed on the housing. The means for tightening the belt includes a motor, a drive train attached to the motor and a drive spool attached to an element of the drive train. (The drive train may include a gear box, a brake, a clutch or combination of these devices.) During use, the drive spool rotates, causing the belt to spool onto the drive spool. Various other mechanisms may be used to tighten the belt, including the mechanisms shown in Lach et al., Resuscitation Method and Apparatus, U.S. Pat. No. 4,774,160 (Sep. 13, 1988) and in Kelly et al., Chest Compression Apparatus for Cardiac Arrest, U.S. Pat. No. 5,738,637 (Apr. 14, 1998).

The compression belt 3 shown in FIG. 1 is provided with a structure that aids in performing anterior-posterior compressions effectively and efficiently. Specifically, the belt is shaped like a double-bladed oar. The wider load distribution sections 16 and 17 of the belt are secured to each other over the patient's chest and apply the bulk of the compressive load during use. The narrow pull straps 18 and 19 of the belt are spooled onto the drive spool of the belt drive platform to tighten the belt during use. The trapezoid-shaped transition sections 20 and 21 reinforce the belt and transfer force from the pull straps to the load distribution sections evenly across the width of the load distribution sections. The narrow end of a trapezoid faces the pull straps and the wide end of a trapezoid faces a corresponding load distribution section.

A compression pad 22 (shown in FIG. 2) filled with reticulated foam and air may be disposed between the load distribution sections and the patient's chest. The compression pad distributes the force of compressions across the chest to help preferentially compress the sternum. An example of a compression pad may be found in our application Ser. No. 10/192,771 filed Jul. 10, 2002.

In use, the patient is placed on the housing, the belt wrapped around the patient's chest and the belt secured with a means 23 for securing the belt. The means for tightening the belt then tightens the belt repetitively to perform chest compressions.

FIG. 2 is a cross section of a variation of our chest compression device 2. The drive spool 40 and motor 41 are located to one side of the patient. The guide spindles 42 (center spindle), 43 (right spindle) and 44 (left spindle) are laterally spaced from each other. The left and right guide spindles are essentially located under the spine 45, several inches laterally of the spine, and lie under the scapula 46 or trapezius 47 region of the patient. This location alters the force profile of the belt, creating a generally anterior to posterior force on the thorax, rather than a circumferentially uniform force profile. The exact location of the guide spindles may be adjusted either further laterally, or medially (back toward the center position immediately under the spine) to increase or decrease the balance between anterior to posterior force and circumferential force applied to the typical patient. The compression pad 22 is disposed between the belt 3 and the patient's sternum 48. The addition of lateral support plates 49 and 50 on the right and left sides of the body provide support for the patient, and also form, with the spinal support plate 51, the gaps through which the belt passes to extend from the cartridge to the patient.

Our chest compression devices were tested on pigs in several experiments conducted by different research entities. Side-by-side tests were conducted with manual CPR and piston driven CPR, both with and without concurrent administration of epinephrine. Epinephrine is a therapeutic agent, specifically a vasoconstrictor with a-adrenergic receptor stimulating properties, recommended for use during Advanced Cardiac Life Support protocols established by the American Heart Association. The experiments showed that our chest compression device, both with and without epinephrine, repeatably produced statistically higher coronary perfusion pressure, myocardial blood flow and cerebral blood flow in pigs in cardiac arrest as compared to corresponding values measured during compressions with a piston-driven device or with manual CPR.

We observed unexpectedly high values of coronary perfusion pressure, myocardial blood flow and cerebral blood flow. We had expected combining our device with epinephrine would have increased total coronary perfusion pressure, myocardial blood flow and cerebral blood flow the same amount as the amount of increase observed when a piston-driven device was combined with epinephrine. Instead, we observed 800% more coronary perfusion pressure than expected, 700% more myocardial blood flow than expected and, most surprisingly, a large total increase in cerebral blood flow where none had been expected.

When the techniques were compared directly with each other, our device and epinephrine produced 265% more coronary perfusion pressure, 550% more myocardial blood flow and 500% more cerebral blood flow than the piston-driven device and epinephrine. (Compared to a piston-driven chest compression device alone, our device and epinephrine produced 320% more coronary perfusion pressure, 1,100% more myocardial blood flow and 500% more cerebral blood flow.) Animals treated with our device and epinephrine had myocardial blood flow and cerebral blood flows that were higher than the corresponding pre-arrest levels. Animals treated with our device had a statistically higher chance of surviving cardiac arrest compared to animals treated with manual compressions or with the piston-driven device.

We also compared the performance of a given chest compression technique versus the same chest compression technique and epinephrine. Animals treated with epinephrine and a piston-driven chest compression device showed about 25% increased coronary perfusion pressure, about 100% increased myocardial blood flow and little improvement in cerebral blood flow, as compared to the piston-driven device alone. Animals treated with epinephrine and our device showed about 214% increased coronary perfusion pressure, about 367% increased myocardial blood flow and about 215% increased cerebral blood flow, as compared to corresponding levels achieved by our device alone. A similar difference was observed when manual compressions and our device were compared. Thus, by every measure combining our device with epinephrine produced a very large and unexpected increase in coronary perfusion pressure, myocardial blood flow and cerebral blood flow.

The difference in performance between the combination of our device and epinephrine and the combination of conventional techniques and epinephrine was surprising and the mechanism that produced the surprising result is not fully understood. Nevertheless, the test results demonstrate that our device achieves a hemodynamic effect that takes advantage of the hemodynamic effects of epinephrine in a way that conventional chest compression techniques cannot.

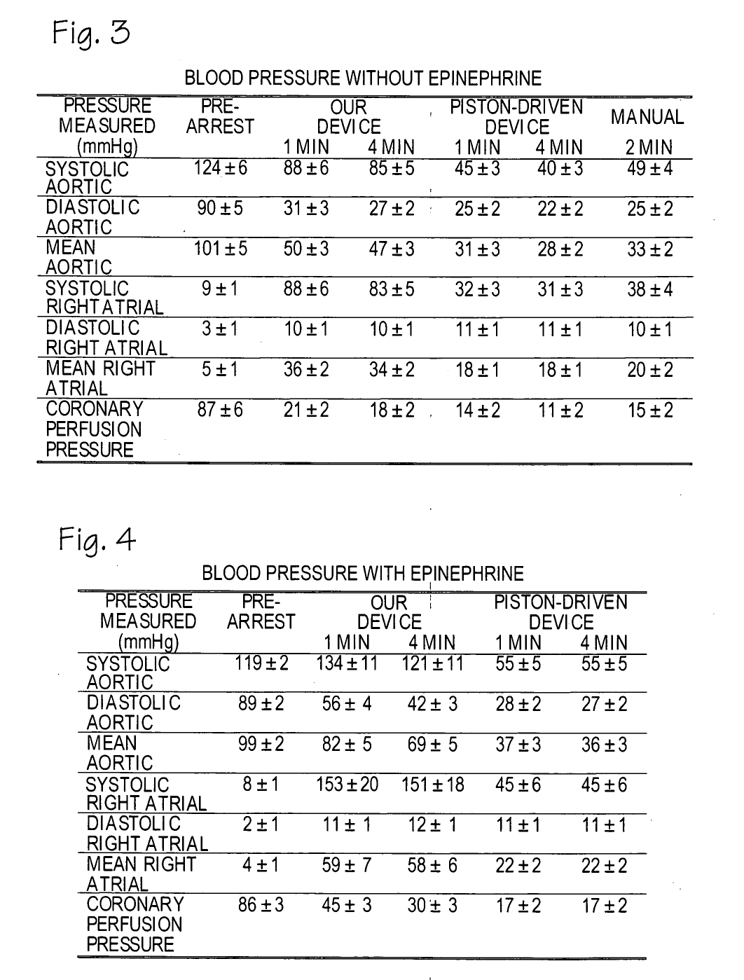

Now turning to the experiments performed, FIGS. 3 through 6 show the results of an animal study using different chest compression techniques, both with and without epinephrine. (The data reported in FIGS. 3 through 6 show mean results±standard error.) During this study, twenty pigs weighing 16±1 kg were anesthetized with ketamine 22 mg/kg IM. Following endotracheal intubation and mechanical ventilation, anesthesia was maintained with isoflurane (1% to 2.5%) in 100% oxygen. Pigs were placed in the supine position and were given 0.5-1.0 L of normal saline intravenously as needed to maintain an euvolemic (normal blood volume) state. Mean right atrial pressures were measured to be between 3 mmHg and 5 mmHg. From bilateral femoral cutdowns, micromanometer-tipped catheters (PC-470; Millar Instruments, Houston, Tex.) were placed into the right atrium and ascending aorta, a pigtail catheter was placed into the descending aorta, and a pacing catheter was placed into the right ventricle. From a carotid cutdown, a pigtail catheter was placed into the left ventricle.

Neutron activated microspheres (from Biophysics Assay Lab) were used to measure regional blood flows with methods that have been previously described and validated for CPR. The first blood flow measurement was made immediately prior to cardiac arrest. Cardiac arrest was induced with 60 Hz alternating current. Ventricular fibrillation was untreated for one minute before CPR protocols were initiated. Ten pigs were studied in each of two protocols to compare hemodynamic performance with and without the use of epinephrine. In the first protocol the pigs were not treated with epinephrine. In the second protocol the pigs were treated with epinephrine. The results of the study are shown in FIGS. 3 through 6.

In Protocol 1 CPR using our device alone and CPR using conventional techniques (manual CPR and piston-driven CPR) alone were compared. Ten pigs received treatment with our device, with a piston-driven device and with manual compressions, all without epinephrine. The pigs were given four treatments of CPR. The first CPR treatment was started using either our device or the piston-driven device, chosen randomly. The second CPR treatment was performed with the other chest compression device. The third CPR treatment was performed with the first chest compression device used. The fourth treatment was performed with manual compressions. CPR with our device and CPR using conventional techniques (piston-driven compressions or manual compressions) were performed with 20% anterior-posterior chest displacement at a rate of 80 compressions per minute. CPR using a piston-driven device was performed with a pneumatic, piston-driven chest compressor (Thumper™, Michigan Instruments). Manual compressions were performed according to American Heart Association guidelines.

The first CPR treatment using our device was continued for four minutes while hemodynamics and regional blood flows were measured. Immediately after completing the first CPR treatment, all animals were transferred to the other device (the piston-driven device or our device) for the second treatment. The second treatment was continued for four minutes while hemodynamics and regional blood flows were measured. After completion of the second treatment, the animals were transferred back to the first chest compression device for,the third treatment. The third treatment was performed for two minutes, and only hemodynamics were recorded. Subsequently, during the fourth treatment, manual CPR was performed for two minutes while hemodynamics were recorded.

The randomized order of initial device used yielded two treatment sequences. The first sequence of treatments, performed on 4 pigs, used the piston driven device, then our device, then the piston-driven device again and then manual compressions. The second sequence of treatments, performed on 6 pigs, used our device, the piston-driven device, then our device again and then manual chest compressions. Our device achieved markedly better perfusion than the piston-driven device or manual chest compressions.

In Protocol 2 CPR using our device and epinephrine was compared to CPR using a piston-driven device and epinephrine. Ten additional pigs received treatment with epinephrine, CPR using our device and CPR using a piston-driven device. Epinephrine was started simultaneously with the first CPR treatment with a 0.5 mg intravenous bolus and a 4 μg/kg/min intravenous infusion that continued for the duration of the protocol. Similar to the treatments given the pigs in protocol 1, the pigs in protocol 2 were given three treatments (the step of performing manual CPR was omitted in protocol 2).

The first CPR treatment was started with either our device or the piston-driven device, chosen randomly, and lasted four minutes. During the second treatment, which lasted four minutes, the other device was used to perform compressions. During the third treatment, which lasted two minutes, the first device was used to perform compressions. The randomized order of initial device used yielded two treatment sequences. The first sequence of treatments, performed on 5 pigs, used the piston driven device, then our device and then the piston-driven device again. The second sequence of treatments, performed on 5 pigs, used our device, the piston-driven device and then our device again.

FIGS. 3 and 4 show the results of the experiment with regard to measured levels of blood pressure. Use of our device with epinephrine improved blood pressure in every location measured, as compared to use of conventional techniques without epinephrine. With regard to coronary perfusion pressure (CPP), the piston-driven device alone produced about 14 mmHg CPP and the piston-driven device and epinephrine produced about 17 mmHg CPP. Our device alone produced about 21 mmHg CPP and our device and epinephrine produced about 45 mmHg CPP. (The animals had an average pre-arrest coronary perfusion pressure of about 86 mmHg).

We had expected to see the difference in coronary perfusion pressure between our device with epinephrine and our device alone to be about the same as the difference between the piston-driven device with epinephrine and the piston-driven device alone. Since we observed an increase of about 3 mmHg in coronary perfusion pressure between the piston-driven device with epinephrine and the piston driven device alone, we expected an increase of about 3 mmHg when epinephrine was added with our device. Instead, we observed an increase of 24 mmHg when epinephrine was added with our device. Thus, we observed 800% more total coronary perfusion pressure than had been expected.

With regard to overall coronary perfusion pressure, combining our device with epinephrine was about 265% more effective than combining the piston-driven device and epinephrine. Combining our device with epinephrine was about 320% more effective than the piston-driven device alone. Testing in both humans and animals has shown that increased coronary perfusion pressure is correlated with a higher survival rate; thus, patients treated with both our device and epinephrine are more likely to survive cardiac arrest.

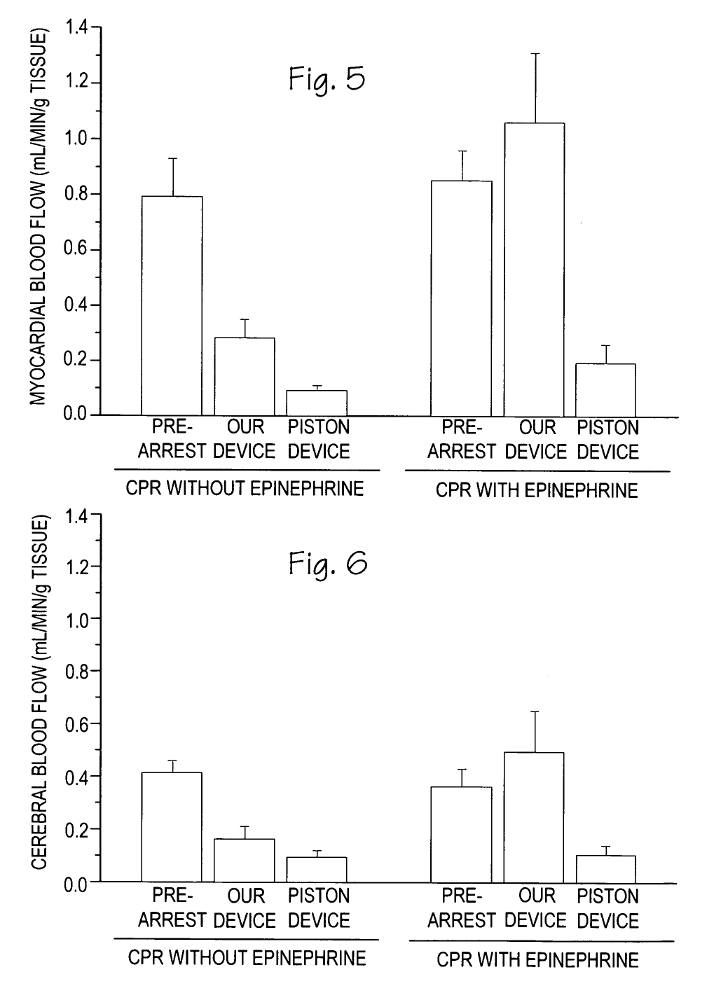

FIG. 5 is a chart showing average myocardial blood flow in pigs during chest compressions, wherein chest compressions were performed using two different techniques and wherein each chest compression technique was performed both with and without the provision of epinephrine. Pre-arrest myocardial blood flow was about 0.8 mL/min/g of tissue. Myocardial blood flow using our device alone was about 0.3 mL/min/g of tissue and with epinephrine it was about 1.1 mL/min/g of tissue (138% of the pre-arrest level). Myocardial blood flow using the piston-driven device alone was about 0.1 mL/min/g of tissue and with epinephrine it was about 0.2 mL/min/g of tissue (25% of the pre-arrest level).

The piston-driven device combined with epinephrine (protocol 2) showed a blood flow of about 0.1 mL/min/g of tissue over the blood flow observed with piston-driven device alone (protocol 1). We therefore expected to see about an increase in myocardial blood flow of 0.1 mL/min/g of tissue when using our device with epinephrine over using our device alone (a total of 0.4 mL/min/g of tissue). Instead, we found that using our device with epinephrine produced a myocardial blood flow of about 0.7 mL/min/g of tissue more than our device alone (a total of 1.1 mL/min/g of tissue). Thus, we observed 700% more total myocardial blood flow over the expected amount of blood flow.

With regard to overall myocardial blood flow, combining our device with epinephrine was about 550% more effective than combining the piston-driven device and epinephrine. Combining our device with epinephrine was about 1,100% more effective than the piston-driven device alone. This large increase in myocardial blood flow increases the chance that the patient will return to spontaneous circulation, especially when defibrillating shocks are applied to the patient.

FIG. 6 is a chart showing average cerebral blood flow in pigs during chest compressions, wherein chest compressions were performed using two different techniques and wherein each chest compression technique was performed both with and without the provision of epinephrine. Pre-arrest cerebral blood flow was about 0.4 mL/min/g of tissue. Cerebral blood flow using our device alone was a little less than 0.2 mL/min/g of tissue and with epinephrine it was about 0.5 mL/min/g of tissue (125% of the pre-arrest level). Cerebral blood flow using the piston-driven device alone was about 0.1 mL/min/g of tissue and with epinephrine it was also about 0.1 mL/min/g of tissue (25% of the pre-arrest level). (Cerebral blood flow was slightly higher when using epinephrine and the piston-driven device, though the increase was statistically insignificant.)

Since there was no statistical change in cerebral blood flow between piston-driven compressions and piston-driven compressions combined with epinephrine, we also expected little change when epinephrine was combined with our device. However, when epinephrine was combined with our device we observed a large, 0.3 mL/min/g of tissue increase in cerebral blood flow over our device alone (a 250% increase).

With regard to overall cerebral blood flow, our device combined with epinephrine was 500% more effective than either the piston-driven device alone or the piston-driven device combined with epinephrine. Since cerebral blood flow is critical to patient survival and neurological function, the large increase in cerebral blood flow means that combining our device with epinephrine is an effective new procedure for treating cardiac arrest patients.

In addition, use of our device produced higher levels of blood flow than conventional CPR at all levels of coronary perfusion pressure. Use of our device with epinephrine early in the course of cardiac arrest produced levels of myocardial and cerebral blood flow that were comparable to pre-arrest levels.

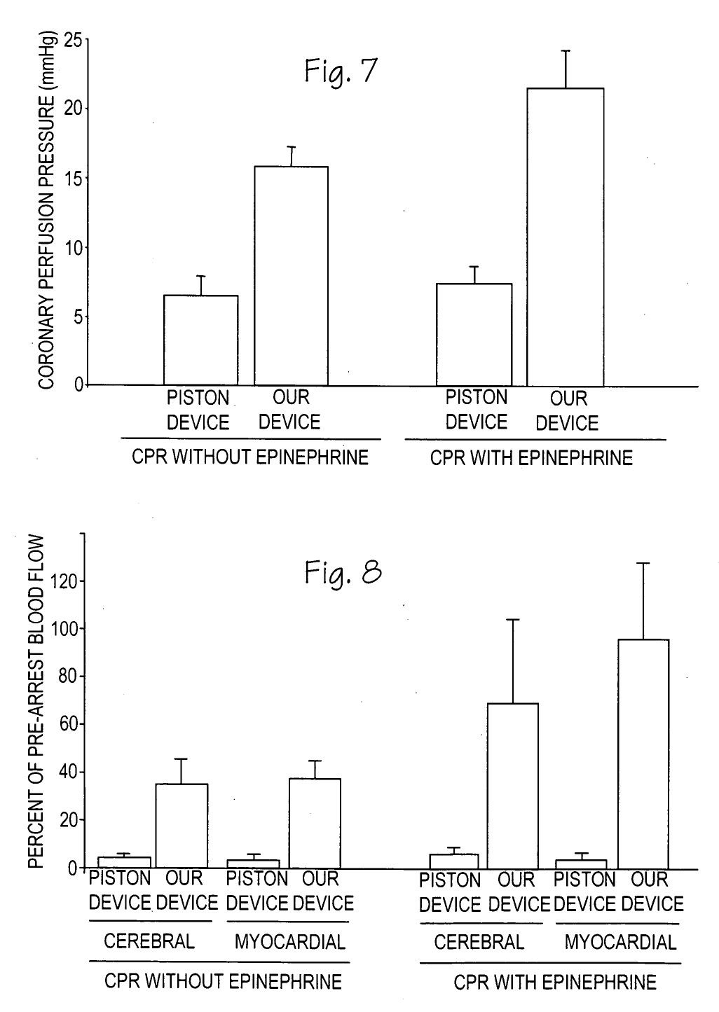

FIGS. 7 through 9 show the results of a second, independent animal study on the effects that two chest compression techniques, applied both with and without epinephrine, have on blood pressure, cerebral blood flow and myocardial blood flow in pigs in cardiac arrest. (The data reported in FIGS. 7 through 9 show mean results±standard error.) Like the first study, the second study compared CPR using our device alone, CPR using a piston-driven device alone, CPR using our device with epinephrine and CPR using a piston-driven device with epinephrine. The second study also found a dramatic and unexpected increase in performance when using our device with epinephrine compared to using the piston-driven device and epinephrine.

During the second study, thirty-two pigs, ranging in weight from 18 kg to 23 kg, were anesthetized with 20 mg/kg IM ketamine. The pigs were then intubated and provided with mechanical ventilation. Anesthesia was maintained with 1% to 2.5% isoflurane in 100% oxygen. Micromanometer-tipped catheters (Millar PC-470) ware placed into the right atrium and the ascending aorta, 8F introducers were placed in both the right and left femoral veins and arteries, a pigtail catheter was placed into the left ventricle and a pacing catheter was placed into the right ventricle. A three-lead electrocardiogram device was applied for monitoring heart electrical activity. The pigs were placed in the supine position and were given 0.5 L to 1.0 L saline intravenously as needed to maintain an euvolemic state (a state of normal blood volume).

Immediately before cardiac arrest was induced, baseline blood samples were collected, pressures in the aorta, right ventricle and the left ventricle were measured, regional blood flow to the brain and heart was measured with microspheres, cardiac function was measured by transthoracic echocardiography, and end-tidal carbon dioxide levels were recorded. Ventricular fibrillation was induced with 60 Hz of alternating current applied to the pacing catheter. Anesthesia and mechanical ventilation were then discontinued. Ventricular fibrillation was untreated for 8 minutes before a CPR protocol was initiated.

The CPR protocols were divided into four phases. During phase one 22 pigs received treatment with CPR using our device and 10 pigs received treatment with CPR using the piston-driven device, each for 4 minutes. In both techniques, 20% anterior-posterior chest displacement was performed with 2 ventilation puffs provided every 15 compressions. Immediately after completing 4 minutes of CPR, compressions were discontinued and defibrillation attempted up to 3 times. Animals that returned to spontaneous circulation were moved to phase 3. Animals that did not return to spontaneous circulation were moved to phase 2.

During phase 2, the remaining pigs were treated with 0.75 mg of intravenous epinephrine and 4 more minutes of compressions. Chest compressions were started using the same compression method and parameters as used prior to defibrillation. After completing 4 minutes of CPR during phase 2, defibrillation using 3 shocks was attempted. If spontaneous circulation did not occur, then an animal was considered a non-survivor. Resuscitated animals were moved to phase 3.

During phase 3, the animals were evaluated during recovery. At 5 minutes after the return of circulation, hemodynamic parameters were again measured. Ten minutes following the return of circulation, mechanical ventilation was gradually reduced until adequate spontaneous ventilation was observed. The endotracheal tube was then removed and the animal moved to phase 4.

During phase 4 the animals were evaluated for neurological function 24 hours following the induction of ventricular fibrillation. In addition, final sets of blood samples were collected and cardiac function and vital signs were measured. Of the 32 animals, 16 of the 22 animals treated with our device recovered.

None of the 10 animals treated with the piston-driven device recovered. Two of the 16 survivors recovered after treatment with our device alone and 6 of the survivors recovered after treatment with our device and defibrillation. Of the 8 survivors that required epinephrine, 2 recovered during chest compressions and 6 recovered after the second defibrillation attempt. After 24 hours, 14 of the 16 survivors showed normal neurological function and 2 of the 16 survivors showed mild dysfunction. Thus, this experiment showed that a combination of our chest compression device, defibrillating shocks, and epinephrine not only dramatically increased the rate of survival in cardiac arrest patients, but also dramatically increased the chance that patients would have normal neurological function after recovery.

FIG. 7 is a chart showing average coronary perfusion pressure in pigs during chest compressions, wherein chest compressions were performed using two different techniques and wherein each chest compression technique was performed with and without the provision of epinephrine. Treatment with intravenous epinephrine significantly increased coronary perfusion pressure in animals treated with our device, but not in animals treated with the piston-driven device. During this study, coronary perfusion pressure during piston-driven CPR was about 7.5 mmHg, and was not statistically higher after epinephrine was applied. On the other hand, coronary perfusion pressure in animals treated with our device alone was about 15 mmHg and, unexpectedly, was about 22.5 mmHg when combined with epinephrine.

We had expected coronary perfusion pressure while using our device with epinephrine to increase about the same amount as the increase observed while using the piston-driven device and epinephrine. Since we had observed a slight, statistically insignificant, increase in coronary perfusion pressure when combining epinephrine with the piston-driven device, we expected to see a similar small change when combining epinephrine and our device. Instead, we observed a large increase in coronary perfusion pressure when combining our device with epinephrine. (In this study our device with epinephrine produced about 325% more coronary perfusion pressure than the piston-driven device, either alone or with epinephrine. Our device with epinephrine produced 131% more coronary perfusion pressure then our device alone.)

FIG. 8 is a chart showing the percentage of pre-arrest blood flow in pigs during chest compressions, wherein chest compressions were performed using two different techniques and wherein each chest compression technique was performed with and without the provision of epinephrine. FIG. 8 shows the amount of blood flow achieved during each type of treatment versus the percentage of pre-arrest blood flow. Cerebral and myocardial blood flow during treatment with our device alone was about 30% of pre-arrest levels, as compared to less than 10% of pre-arrest levels during treatment with the piston-driven device alone. Cerebral blood flow during treatment with our device with epinephrine was about 70% of pre-arrest levels, as compared to less than 10% of pre-arrest levels during treatment with the piston-driven device and epinephrine. Similarly, myocardial blood flow during treatment with our device with epinephrine was about 90% of pre-arrest levels, as compared to less than 10% of pre-arrest levels during treatment with the piston-driven device and epinephrine.

As with the first animal study, we observed only a slight increase in cerebral and myocardial blood flow when using the piston-driven device with epinephrine, as compared to cerebral and myocardial blood flow when using the piston-driven device without epinephrine. Similarly, we observed a proportionately much larger increase in cerebral and myocardial blood flow when using our device with epinephrine, as compared to cerebral and myocardial blood flow when using our device without epinephrine.

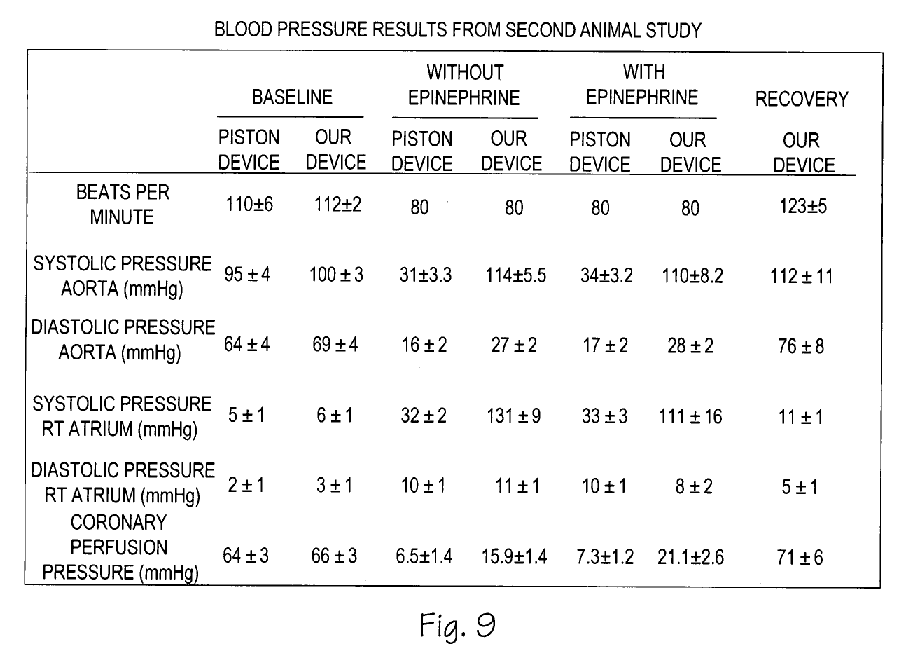

FIG. 9 is a table showing average blood pressure in pigs during chest compressions, wherein chest compressions were performed using two different techniques and wherein the chest compression techniques were performed both with and without the provision of epinephrine. The data again confirms that treating cardiac arrest with our device and epinephrine is unexpectedly much more effective than treating cardiac arrest with a piston-driven device and epinephrine.

Since combining the piston-driven device with epinephrine produced a statistically insignificant increase in coronary perfusion pressure over the piston-driven device alone, we expected little change over our device alone when we combined our device with epinephrine. However, we observed a 33% increase in coronary perfusion pressure over our device alone when our device was combined with epinephrine. Thus, we were surprised to observe such a large increase in coronary perfusion pressure.

In addition to the two animal studies described above, we also performed one human study with terminally ill human patients in a hospital setting. The study compared the affect that our device and epinephrine had on coronary perfusion pressure in patients in cardiac arrest versus the affect that manual CPR and epinephrine had on coronary perfusion pressure in the same patients. Sixteen patients that spontaneously went into cardiac arrest were treated with advanced life support protocols, which included manual CPR, defibrillation and epinephrine as medically indicated. Those that did not respond to accepted advanced life support protocols after 10 minutes were also treated with our device, while epinephrine and defibrillating shocks continued as medically indicated. During treatment with our device, fluid-filled catheters were advanced into the thoracic aorta and right atrium to measure blood pressure in those regions. The patients received alternating periods of 90 seconds of treatment with our device and periods of 90 seconds of treatment with manual CPR.

In 15 of the 16 patients, coronary perfusion pressure was observed to be substantially higher while using our device as compared to manual compressions. On average, coronary perfusion pressure was about 15 mmHg during manual CPR and was about 20 mmHg during treatment with our device (about 30% higher, which is about the increase in coronary perfusion pressure found in the second animal study). Thus, we have strong evidence that our device statistically increases coronary perfusion pressure in human cardiac arrest patients.

All three of these experiments provide evidence that treating a patient in cardiac arrest with our device will substantially increase coronary perfusion pressure relative to conventional CPR techniques. In the two animal studies, the increase in coronary perfusion pressure was dramatic when our device was combined with epinephrine. Similarly, compared to conventional techniques, the animals showed dramatic and unexpected increases in myocardial blood flow and cerebral blood flow when treated with our device and epinephrine.

Because the time to save a patient is so short, and because epinephrine is indicated for patients in either ventricular fibrillation or asystole (and for all patients requiring advanced cardiac life support), a human cardiac arrest patient should be treated with both our device and epinephrine as soon as possible. Thus, the treatment of cardiac arrest patients with our device and epinephrine should be part of both basic life support protocols and advanced life support protocols. First responders, such as police, fire fighters, paramedics and emergency medical technicians should administer epinephrine in the field as soon as our device has been deployed on a patient and activated. (First responders are those trained in performing basic life support, but who are unauthorized to administer procedures ascribed to the advanced cardiac life support protocols.)

Thus, a method that first responders can use to perform basic life support on a patient in cardiac arrest is to provide a device for performing chest compressions on the patient, said device having a belt, wherein the chest compression device is capable of compressing the chest of the patient with the belt, is adapted to perform anterior-posterior chest compressions on the patient and has a weight low enough to allow a human rescuer to carry the chest compression device; provide a dose of epinephrine, said dose suitable for treating a patient in cardiac arrest; provide a means for administering the dose of epinephrine to the patient; perform anterior-posterior chest compressions on the patient with the device; and administer the dose of epinephrine to the patient. This method of performing basic life support may be supplemented by administering defibrillating shocks, as medically indicated. (Any suitable means for administering a defibrillating shock may be used, such as an automatic external defibrillator or other defibrillator.) Epinephrine may also be administered by a limited-access or automatic drug delivery system provided with our chest compression device. This feature will allow an untrained bystander to secure the device to the patient and begin treatment immediately. Thus, the patient can receive anterior-posterior chest compressions and a dose of epinephrine before first responders arrive, thereby further increasing the chance that the patient will survive cardiac arrest.

Based on our experiments we conclude that a patient treated with basic life support should receive, in addition to having chest compressions performed by our device, a standard dose of epinephrine (about 1 mg intravenous push and 1 mg epinephrine administered every 3 to 5 minutes). The dose of epinephrine may be from about 1 mg epinephrine to about 10 or more mg epinephrine IV push plus about 1 mg epinephrine to about 10 or more mg epinephrine about every 3 to 5 minutes. If epinephrine is administered based on the patient's weight, the does should be about 0.01 mg/(Kg patient weight) to about 0.2 mg/(Kg patient weight) IV push and about 0.01 mg/(Kg patient weight) to about 0.2 mg/(Kg patient weight) about every 3 to 5 minutes. (During advanced life support a physician or other appropriate caretaker can monitor the patient and intervene should complications arise.)

While the preferred embodiments of the devices and methods have been described in reference to the environment in which they were developed, they are merely illustrative of the principles of the inventions. Other embodiments and configurations may be devised without departing from the spirit of the inventions and the scope of the appended claims.

1. A method of performing basic life support on a patient in cardiac arrest, said method comprising the steps of:
providing a device for performing chest compressions on the patient, said device having a belt, wherein the chest compression device is capable of compressing the chest of the patient with the belt, is adapted to perform anterior-posterior chest compressions on the patient and has a weight low enough to allow a human rescuer to carry the chest compression device;
providing a dose of epinephrine, said dose suitable for treating a patient in cardiac arrest;
providing a means for administering the dose of epinephrine to the patient;
performing anterior-posterior chest compressions on the patient with the device; and
administering the dose of epinephrine to the patient.

2. The method of claim 1 wherein the method is performed by a first responder.

3. The method of claim 2 wherein the first responder is selected from the group consisting of fire fighters, police officers, paramedics and emergency medical technicians.

4. The method of claim 1 comprising the further steps of:
providing a means for delivering a defibrillating shock to the patient; and
delivering a defibrillating shock to the patient.

5. The method of claim 4 wherein the method is performed by a first responder.

6. The method of claim 5 wherein the first responder is selected from the group consisting of fire fighters, police officers, paramedics and emergency medical technicians.

7. A method of treating a patient, wherein the patient is located in the field, said method comprising the steps of:
providing a device for performing chest compressions on the patient, said device having a belt, wherein the chest compression device is capable of compressing the chest of the patient with the belt, is adapted to perform anterior-posterior chest compressions on the patient and has a weight low enough to allow a human rescuer to carry the chest compression device;
providing a dose of epinephrine, said dose suitable for treating a patient in cardiac arrest;
providing a means for administering the dose of epinephrine to the patient;
performing anterior-posterior chest compressions on the patient with the device; and
administering the dose of epinephrine to the patient.

8. The method of claim 7 wherein the method is performed by a first responder.

9. The method of claim 8 wherein the first responder is selected from the group consisting of fire fighters, police officers, paramedics and emergency medical technicians.

10. The method of claim 7 comprising the further steps of:
providing a means for delivering a defibrillating shock to the patient; and
delivering a defibrillating shock to the patient.

11. The method of claim 10 wherein the method is performed by a first responder.

12. The method of claim 11 wherein the first responder is selected from the group consisting of fire fighters, police officers, paramedics and emergency medical technicians.

13. A method of treating a patient, said method comprising the steps of:
providing a device for performing chest compressions on the patient, said device having a belt, wherein the chest compression device is capable of compressing the chest of the patient with the belt, is adapted to perform anterior-posterior chest compressions on the patient and has a weight low enough to allow a human rescuer to carry the chest compression device;
providing a dose of epinephrine, said dose suitable for treating a patient in cardiac arrest;
providing a means for administering the dose of epinephrine to the patient;
performing anterior-posterior chest compressions on the patient with the device; and
administering the dose of epinephrine to the patient.

14. The method of claim 13 comprising the further steps of:
providing a means for delivering a defibrillating shock to the patient; and
delivering a defibrillating shock to the patient.
